(19) United States
(12) Patent Application Publication
(10) Pub. No.: US 2009/0285721 A1
(43) Pub. Date: Nov. 19, 2009

(54) Apparatus for chemical analysis of a sample

(75) Inventors: Jason DeGreeve, Calgary (CA); Brian Eley, Calgary (CA); Marceau van Beurden, Calgary (CA)

Correspondence Address: GOWLING LAFLEUR HENDERSON LLP, SUITE 1600, 1 FIRST CANADIAN PLACE, 100 KING STREET WEST, TORONTO, ON, M5X 1G5, CA

(73) Assignee: Pason Systems Corp., Calgary (CA)

(21) Appl. No.: 12/153,224

(22) Filed: May 15, 2008

(51) Int. Cl. G01N 21/59; G01N 21/01; G01N 21/55

(52) U.S. Cl. 422/82.09; 422/82.05

(57) ABSTRACT

The present invention provides an apparatus for the chemical analysis of a sample.

### FIELD OF THE INVENTION

The invention relates to an apparatus for the chemical analysis of a sample. More particularly the invention relates to an automated apparatus and method for the chemical analysis of a sample including a self cleaning component.

### BACKGROUND OF THE INVENTION

In many situations samples are provided that need to be analysed for their chemical composition. For example, in laboratories samples are routinely analysed. In many situations samples are required to be analysed before further work can be undertaken. For example, in the drilling and mining field.

During the drilling process of a well, for example natural gas or oil wells, drilling mud is forced through the drill bit to the surface of the well site. This drilling mud is subsequently analysed to ascertain its chemical composition. The composition of the drilling mud is important to know in order for the operator of the drill to be able to operate the drill within the appropriate and optimal parameters for the specific conditions, i.e. the chemical composition of the drilling mud within which the drilling is taking place.

Chemical analysis of drilling mud is generally undertaken using manual techniques. Such manual techniques involve a technician being responsible for the addition of any chemical reagents required for the analysis as well as the identification of a visual colour change endpoint in the analysis.

Other known techniques involve the use of ion selective probes for taking a direct measurement of the mud or filtrate to determine the chemical concentrations within the mud. Alternative techniques include the use of spectroscopy for the determination of the chemical concentration of the mud.

Generally these techniques are time consuming since they involve a manual component. Further, ion selective probes are not rugged enough to withstand the drilling rig environment. In addition, since the analysis involves an element of human interpretation, i.e. assessment of the color change endpoint, there is generally no consistency in the results.

### SUMMARY OF THE INVENTION

The present invention provides an automated apparatus for the analysis of a substance, for example a drilling fluid or mud.

In one aspect, the present invention provides an apparatus for chemically analysing a sample comprising a chamber operable for receiving at least one sample and at least one reagent, the chamber having a lower and an upper portion, at least one optical sensor, connected to the chamber, operable to optically analyse the at least one sample and a piston located within the chamber, operable to move between the lower and the upper portions, the piston operable to provide a seal with the chamber when the piston is located in the lower portion and operable to allow the passage of the at least one sample and the at least one reagent through the chamber when located in the upper portion.

In a further aspect, the present invention provides an apparatus for measuring ion concentrations in a sample comprising a chamber fluidly connected to a sample vessel and at least one reagent vessel and configured to receive a sample and at least one reagent from the vessels, the chamber being configured to allow for the transmission of light therethrough, at least one optical sensor connected to the chamber and configured to analyse the sample when received within the chamber, and a piston located within the chamber, operable to move between a first position and a second position, the piston operable to provide a seal with the chamber when located in the first position, to contain the sample and the at least one reagent therein, and operable to allow passage of the sample and the at least one reagent through the chamber when the piston is located in the second position.

In an alternative embodiment the present invention provides an apparatus as described herein in which the optical sensor is selected from at least one transmissive sensor and at least one reflective sensor.

In an alternative embodiment the present invention provides an apparatus as described herein in which the piston is operable to engage the inner surface of the lower portion of the chamber. The piston may comprise a flexible portion located around the periphery of the piston, operable to frictionally engage the inner surface of the lower portion of the chamber.

In an alternative aspect the present invention provides an apparatus that further comprising an agitator connected to the chamber and operable to promote mixing of the at least one sample and the at least one reagent within the chamber.

In an alternative aspect the present invention provides an apparatus for measuring ion concentrations in a sample comprising a chamber configured to receive a sample and at least one reagent, the chamber having a lower portion configured to allow the passage of light therethrough and an outlet port, at least one optical sensor connected to the chamber adjacent the lower portion and operable to analyse the sample through the outer walls of the lower portion, when the sample is located therein, a plug portion operable to move between a first position in which the plug portion covers the outlet port and a second position in which the sample and at least one reagent are fluidly connected to the outlet port, the plug portion configured to clean the lower portion when moving between the first and second positions.

In a further aspect the present invention provides a method of analysing a sample using an automated chemical analysis apparatus having an analysis chamber including the steps of (i) sealing the analysis chamber; (ii) providing a sample to be analysed; (iii) providing at least one reagent; (iv) agitating the sample and the at least one reagent if desired; (v) analysing the sample using at least one optical sensor; (vi) opening at least one outlet port located in the analysis chamber to empty the chamber; (vii) cleaning the analysis chamber using a cleaning device located in the analysis chamber; and (viii) repeating steps (i) to (vii) as required.

### BRIEF DESCRIPTION OF THE DRAWINGS

The present invention will now be described in further detail with reference to the following figures:

FIG. 1 is a side view of one embodiment of the apparatus of the present invention;

FIG. 2a is a side view of one embodiment of the apparatus of the present invention;

FIG. 2b is a cross sectional side view of the apparatus of FIG. 2a taken along line A-A, showing the piston located in the lowered position;

FIG. 3a is a side view of one embodiment of the apparatus of the present invention;

FIG. 3b is a cross sectional side view of the apparatus of FIG. 3a taken along line A-A, showing the piston located in a raised position;

FIG. 4 is a partial side view of one embodiment of the apparatus of the present invention showing a transmissive sensor assembly, with the internal components shown in dashed lines;

FIG. 5 is a partial side view of one embodiment of the apparatus of the present invention showing a reflective sensor assembly, with the internal components shown in dashed lines;

FIG. 6a is a perspective view of one embodiment of the apparatus of the present invention showing an agitator port;

FIG. 6b is an enlarged view of the portion of FIG. 6a circled at letter A;

FIG. 7 is an exploded view of a portion of the apparatus of the present invention seen from below;

FIG. 8 is an exploded top view of the apparatus of the present invention including a reflective sensor assembly;

FIG. 9 is an exploded view of the apparatus of the present invention including a transmissive sensor assembly; and

FIG. 10 is a perspective view of one embodiment of the apparatus of the present invention.

### DETAILED DESCRIPTION OF THE PREFERRED EMBODIMENTS

The present invention provides an apparatus for chemical analysis of a sample. Further the present invention provides an automated apparatus for chemical analysis of a sample including a self cleaning component. In one embodiment the present invention provides a titration apparatus for the analysis of a sample such as drilling mud or drilling mud filtrate.

The present invention provides an automated apparatus for the chemical analysis of a sample, such as drilling mud, which includes an automated self cleaning component.

The present invention will be described in detail with reference to the accompanying Figures. The figures represent one embodiment of the apparatus of the present invention in which the apparatus is used as a titration apparatus for the analysis of drilling mud. It will, however, be understood by a person skilled in the art that the apparatus of the present invention may be used for the chemical analysis of any substance and is not limited to the analysis of drilling mud or to the specific chemical analysis described herein.

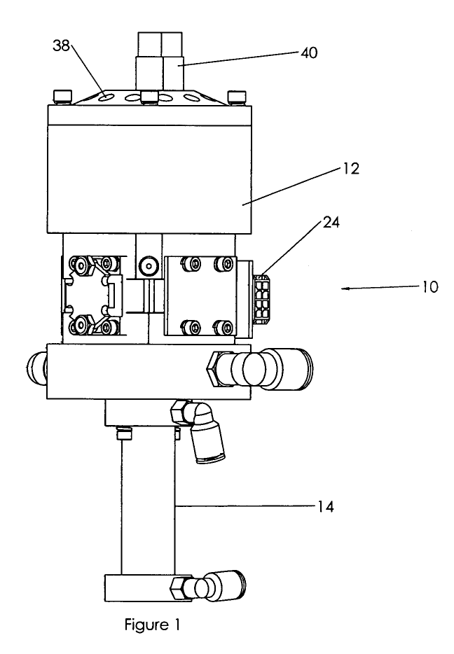

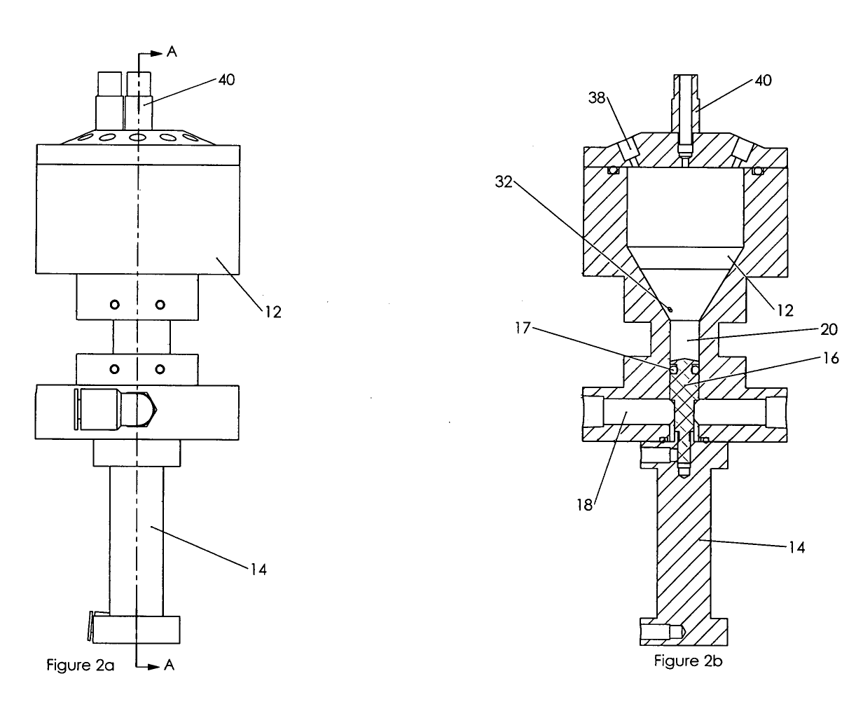

As can be seen in FIG. 1 the apparatus, indicated generally at numeral 10, includes a chamber 12 located above a pneumatic piston assembly 14. The piston assembly 14 includes a piston 16, shown in FIG. 2, that is operable to move in and out of the piston assembly 14 between a raised position and a lowered position, discussed in further detail below. It will be understood that the piston assembly may be a pneumatic piston assembly, a hydraulic piston assembly, or any other means known in the art that provides for the movement of the piston in the manner described herein.

The chamber 12 is sized to receive a sufficient amount of sample to be analysed, i.e. drilling mud filtrate, and a sufficient amount of reagents required for the analysis. Initially, and prior to the analysis and the feeding of the drilling mud filtrate into the chamber 12, the drilling mud is first placed in a filter press, or other filtering device. In one embodiment of the filter press, the drilling mud is pressurized and passed through a filter paper thereby providing a filtered drilling mud product, i.e. the drilling mud filtrate. This filtrate is then used for the subsequent analysis. It will be understood that the filter press may be separate from the titration apparatus or may be part of the apparatus and feed the drilling mud filtrate through to the chamber. In either embodiment, the apparatus 10 includes a means for feeding the drilling mud filtrate into the chamber 12, for example an injector port.

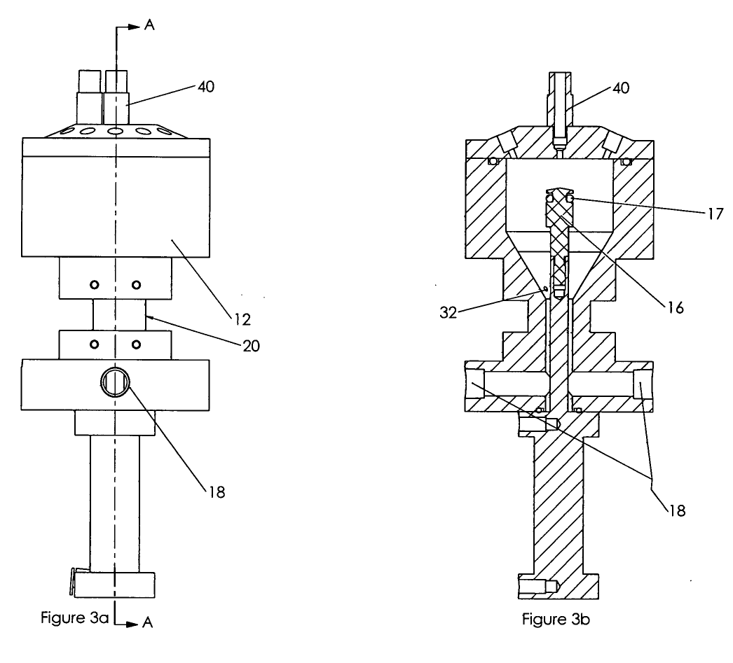

Turning to FIGS. 2 and 3, in the illustrated embodiment the chamber 12 has an upper portion that is funnel shaped and a lower cylindrical portion. The lower portion of the chamber 12 forms the analysis chamber 20 which is located adjacent at least one color monitoring sensor. The analysis chamber 20 may be the entire lower portion of the chamber 12 or may be simply a portion of it, provided that the analysis chamber 20 is of a size that allows the sensors to be positioned around it in order to analyse the sample located within it. In the embodiment shown in the accompanying figures the apparatus 10 includes two optical sensors/color monitoring sensors, a transmissive sensor 22 and a reflective sensor, also referred to herein as a reflective sensor module 24.

It will be understood that the upper portion of the chamber 12 may be formed of any shape provided that it is operable to function in the manner described herein, e.g. to receive sample and reagents. The lower portion of the chamber 12 may be any size provided it is operable to receive the piston 16 within it and provided the piston 16 is operable to seal the bottom of the chamber 12 and to clean the sides of the lower portion of the chamber 12, as described in further detail below. Further, the lower portion of the chamber 12, and in particular the analysis chamber 20, must be sized to receive sufficient amounts of the sample and reagents for analysis. The chamber may be machined from one solid piece of clear cast acrylic and the locations that need to be optically clear, i.e. the portions through which the analysis is performed using the sensors described herein, may be polished either by hand or by machine. The lower portion of the chamber 12 may be any shape provided it is complementary to the shape and size of the piston 16. These two parts should be sized and shaped to ensure that the piston is operable to engage the inner surface of the lower portion of the chamber 12.

As an example, in one embodiment, the lower portion of the chamber 12 is cylindrical in shape and is operable to receive approximately 1 ml of the drilling mud filtrate. The cylinder is sized to have sufficient height for the fluid to cover the optical path between the optical sensors and the LEDs/light source. The piston 16 is also cylindrical in shape to fit within the lower portion of the chamber 12 and abut the inner surface of the lower portion.

The upper portion of the chamber 12 includes at least one injector port 38 through which fluid, e.g. sample and/or reagents may be received. The upper portion of the chamber 12 is sized to include a sufficient number of injector fittings, i.e. one injector fitting connected to an injector port for each reagent required for the analysis, mounted about its periphery, e.g. 12 reagent injector fittings. However, it should be noted that the apparatus is not limited to this embodiment. The lower portion of the chamber may be sized to receive any quantity of fluid to be analysed provided that the chamber 12 of the present invention is able to operate as described herein. Likewise, the upper portion of the chamber may be sized to accommodate different numbers of injector fittings and to hold varying quantities of fluid, provided it operates as described herein.

At the lower end, i.e. the cylindrical end, of the chamber 12 there is located at least one outlet port 18. In the illustrated embodiment the chamber 12 includes two outlet ports 18. The outlet ports 18 are located at a position that allows for the flow of the drilling mud filtrate and reagents, and any additional fluids, used in the analysis to be removed from the chamber 12.

As discussed above, the piston 16 is operable to move between two positions. The lowered position is illustrated in FIG. 2b in which the piston 16 is located at the lower end of the chamber 12 and covers, i.e. blocks, the outlet ports 18. In this position the piston 16 provides a sealed floor within the chamber 12 which provides a sealed space for the analysis to occur. In this configuration the piston acts like a plug and blocks the outlet ports 18. When the piston 16 is in the raised configuration, illustrated in FIG. 3b, it is located in the upper portion of the chamber 12 away from the outlet ports 18 and allows for substances, i.e. sample and reagents, to freely pass by the piston 16 through the analysis chamber 20 and out through the outlet ports 18.

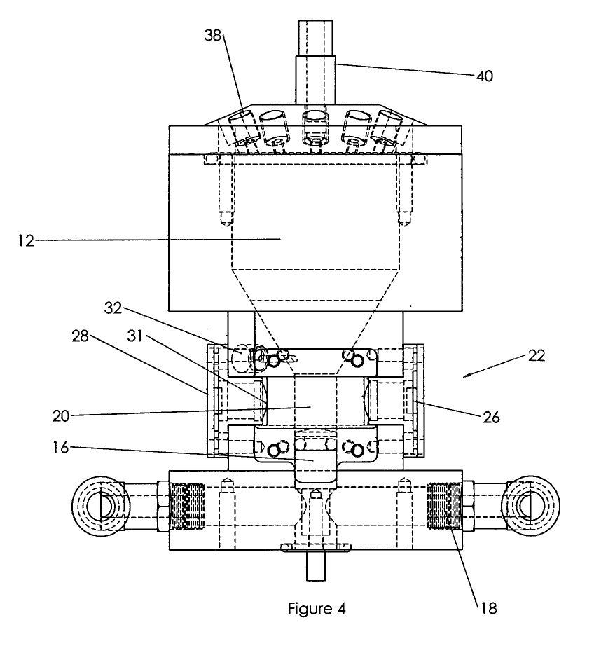

The piston 16 is sized to be received with the lower portion of the chamber 12 and to provide a frictional fit with the internal walls of the lower portion of the chamber 12. The frictional fit may be provided by having a band or ring made of flexible material around the periphery of the piston 16. Alternatively the piston 16 may be partially or completely made of a material that provides a frictional fit between the piston 16 and the inner surface of the lower portion of the chamber 12, and in particular the analysis chamber 20. As illustrated, the frictional fit may be provided by the use of a rubber o-ring 17, clearly shown in FIGS. 3 and 4, located around at least a portion of the piston 16. This frictional fit allows the piston 16 to abut against the internal walls of the lower end of the chamber 12, and particularly the analysis chamber 20, which further allows the piston 16, and in particular the o-ring 17, to scrape the inner surface of the walls to maintain a clear optical path within the lower end of the chamber 12, and in particular within the analysis chamber 20. This acts as a cleaning mechanism to provide a clean inner surface to allow for accurate optical readings.

As stated above, the apparatus 10, of the illustrated embodiment, includes two optical/color monitoring sensors, a transmissive sensor 22 and a reflective sensor module 24. The transmissive sensor 22 is clearly illustrated in FIG. 4 and includes at least one light emitting diode (LED) 26 and at least one transmissive optical sensor 28 located on the opposing side of the analysis chamber 20 from the LED 26. The transmissive sensor 22 is located outside the walls of the analysis chamber 20 which, as stated above, is formed of an optically clear material to ensure the transmission of light.

In the illustrated embodiment, the LED 26 is a tri-color LED. In operation, the LED 26 is operable to cycle through each of its three colors: red, green and blue. Simultaneously, the transmissive optical sensor 28 measures the amount of each color received. Depending on the color of the solution located between the LED 26 and transmissive optical sensor 28, i.e. the sample being analysed, different amounts of red, green and blue will be absorbed. From the received light values the fluid color can be continuously calculated. It will be understood that the LED 26 of the transmissive sensor 22 may be, but is not limited to, one or more LEDs, a bi-color LED or a tri-color LED. It will also be understood that other optical sensors may also be used that allow for the analysis of the sample.

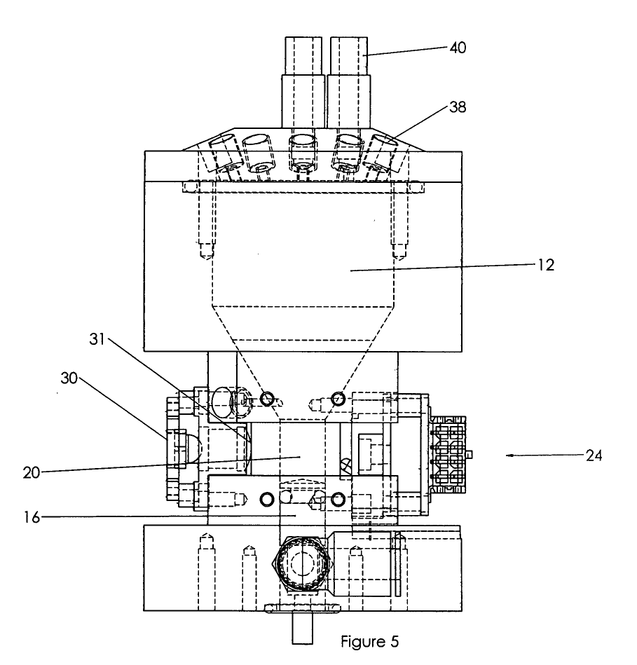

The reflective sensor module 24, shown in FIG. 5, includes at least one light source and at least one reflective optical sensor located on the same side as the light source. The reflective optical sensor includes at least four sensors of which one is a blue filter, one a red filter, one a green filter and one having no filter. The wall of the analysis chamber 20 located opposite the reflective sensor module 24 is machined flat to prevent light from reflecting in the wrong direction. Other means of ensuring minimal interference with the reflected light may be used. The type of light source that may be used includes any light source with one or more wavelengths present, for example a white light source. As stated above, other optical sensors may also be used.

The reflective sensor module 24 is also used for determining the color of the fluid being analysed. Specifically the reflective sensor module 24 is used for the chloride ion titration because during this reaction a white precipitate generally forms which scatters and blocks the light from the transmissive sensor 22 resulting in inaccurate color readings. It will be understood by a person skilled in the art that the reflective sensor module 24 may be used for other non-precipitate forming titrations also.

In the illustrated embodiment, the analysis chamber 20 includes a second light source 30 located opposite the reflective sensor module 24 which provides additional confirmation of the color measurement. Alternative configurations of the optical sensors may be used.

The sensors 22, 24 may further include focusing optics 31. The focusing optics 31 may be located on the LED 26 of the transmissive sensor 22 and on the transmissive optical sensor 28 to focus the light into the transmissive sensor 22 and out of the LED 26. The light source of the reflective sensor module 24 may also include a focusing optic 31. Such optics are known to persons skilled in the art and are used in, for example, microscopes, illumination, camera lenses and barcode readers.

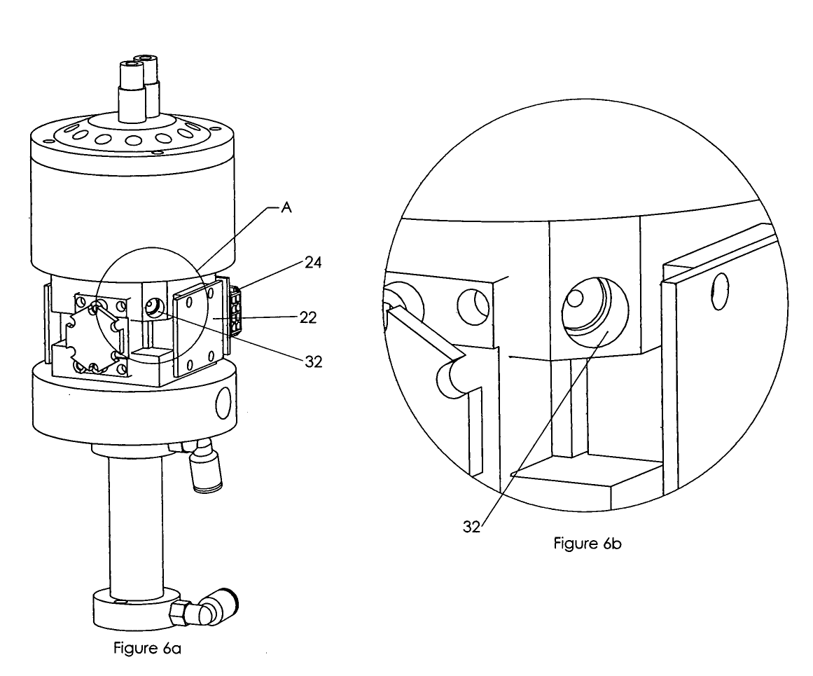

The lower portion of the chamber 12 further includes at least one agitator port 32 for receiving fluid or gas therethrough. The at least one agitator port 32 is located either at the upper portion of the analysis chamber 20, or above the analysis chamber 20, as clearly indicated in FIG. 6. The at least one agitator port 32 is connected to a gas supply, not shown, that supplies gas directly into the analysis chamber at a position that is above the sample being analysed, i.e. drilling mud filtrate. The gas that is supplied agitates the sample being analysed and promotes mixing of the sample and reagents being used. An example of the type of gas that may be used is low pressure air. Other forms of agitation may be used that will provide sufficient agitation to promote mixing of the sample and reagents being used while minimising any interference between the agitator and the sample and reagents that may have a negative impact on the analysis. Examples of alternative agitation means include, but are not limited to, a propeller, the use of spinning magnets to promote mixing etc.

Connected to the apparatus 10 is a supply assembly, not shown, that includes at least one pump for supplying the reagents, e.g. fluids/chemicals, required for the chemical analysis. In one embodiment, the supply assembly includes one pump for each reagent that is required in the apparatus 10. In addition, the supply assembly includes one pump for supplying the drilling mud filtrate. The at least one pump is connected to at least one injector port 38 located on the chamber 12. The at least one pump is regulated for control of the reagent from the pump to the apparatus 10. The injector port(s) are positioned on the chamber 12 at an angle to allow the reagents passing through the injector port(s) to be received in the center of the lower portion of the chamber 12.

The types of analysis that may be performed in the chamber 12 include, but are not limited to: Calcium Ion Concentration Tests, Chloride Ion Concentration Test, and the Pf Mf test which is used to estimate the concentration of the hydroxyl ion (OH⁻), carbonate ion (CO₃²⁻), and bicarbonate ion (HCO₃⁻). An example of the reagents that may be used for this analysis are as follows: (a) Chemicals used in the Calcium Ion Concentration: Versenate Hardness Indicator, Versenate 400, Versenate 4000, Sodium Hydroxide; (b) Chemicals used in the Chloride Test: Potassium Chromate Indicator, Thymol Blue Indicator, N/50 Sulfuric Acid, 0.0282N Silver Nitrate, 0.282N Silver Nitrate; and (c) Chemicals used for the Pf, Mf Test: N/50 Sulfuric Acid, Thymol Blue Indicator, Bromocresol Green Indicator. However, it will be understood that the above tests and reagents are provided as examples only and are not meant to be limiting. Other reagents and tests may be included.

Located at the upper portion of the chamber 12 is at least one fluid supply line 40, shown in FIGS. 1-5, which is in fluid communication with the chamber 12 and is operable to supply at least one of air and water to the chamber 12. The at least one fluid supply line 40 is regulated so that the amount of air and/or water supplied to the chamber 12 is controlled. The air and/or water is used to flush through the chamber 12 to clean the chamber prior to and in between any analysis. In one embodiment, both air and water are used to flush through the system. The air and water may be supplied through separate supply lines 40. In the illustrated embodiment, the water supply line is positioned so that the water, when entering the chamber 12, hits the piston 16, when in the raised position, and flushes out the system. The air supply line then pumps air into the chamber to force the water through the chamber. The air is regulated to ensure that the water is flushed out of the system and does not fill the chamber 12 and place any undue pressure on the injector ports and supply pumps and lines. For example, the air may be regulated at approximately 10 psi. The air supply line may be connected to a 3-way valve which is also used to vent the air out of the chamber coming from the agitator.

In use the sample, e.g. drilling mud filtrate, to be analysed is fed into the chamber 12 When the sample is fed into the chamber 12 the piston 16 is located in the lowered position, thereby blocking the sample from the outlet ports 18. Once within the chamber 12 the sample moves down towards the analysis chamber 20. The sensors 22, 24 are then used to analyse the sample, and any additional reagents required for the analysis are fed into the chamber 12 through injector port(s) 38. A person skilled in the art will know the types of reagents required for each separate analysis and the amounts required, based on the chamber size and the amount and type of sample provided.

In operation the transmissive sensor 22 is calibrated prior to each test or analysis using distilled water. The piston 16 is lowered and distilled water is pumped into the chamber 12 and the received light values of red, green and blue are measured and used as baseline values for calculating the reaction colors.

For the chloride ion analysis, in operation, the light source in the reflective sensor module 24, e.g. white LED reflects off the colored solution and back into the reflective optical sensor located on the same side of the analysis chamber 20 as the light source. The solution color is measured based on the reflected received light.

During the analysis, air may be introduced through agitator port 32 to agitate the substances located in the analysis chamber to assist in the mixing of the sample and the reagents.

Once the chemical analysis is complete the piston 16 moves to a raised position which opens up access to the outlet ports 18. Water and air may be introduced through fluid supply line 40 to flush all the substances through the chamber 12 and out of the outlet ports 18. When the piston 16 is lowered again, the o-ring 17 will scrape against the walls of the analysis chamber thereby cleaning them prior to any subsequent analysis. The cleaning of the walls of the analysis chamber 20 ensures that the optimal optical conditions are maintained for the sensors 22,24.

As will be understood from the above description the entire analysis is automated. The apparatus described herein provides an automated apparatus that is also self-cleaning.

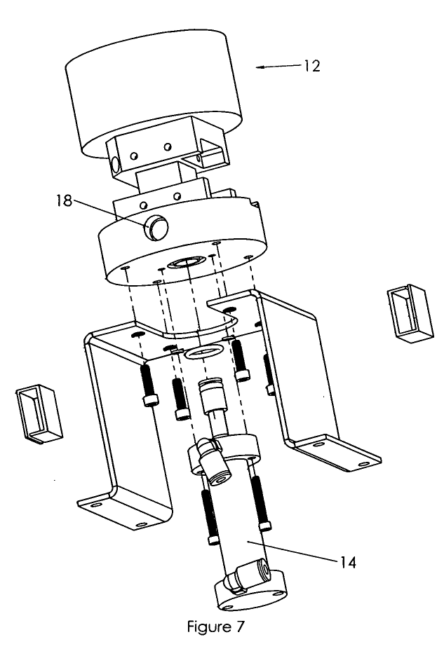

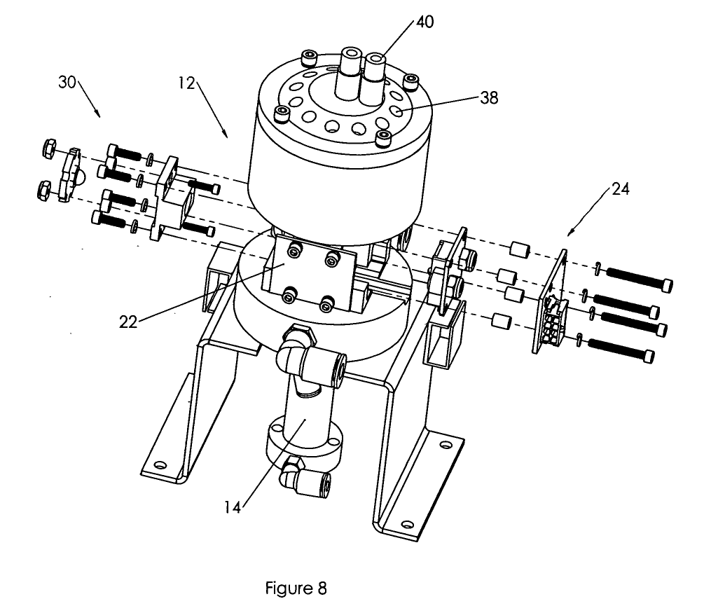

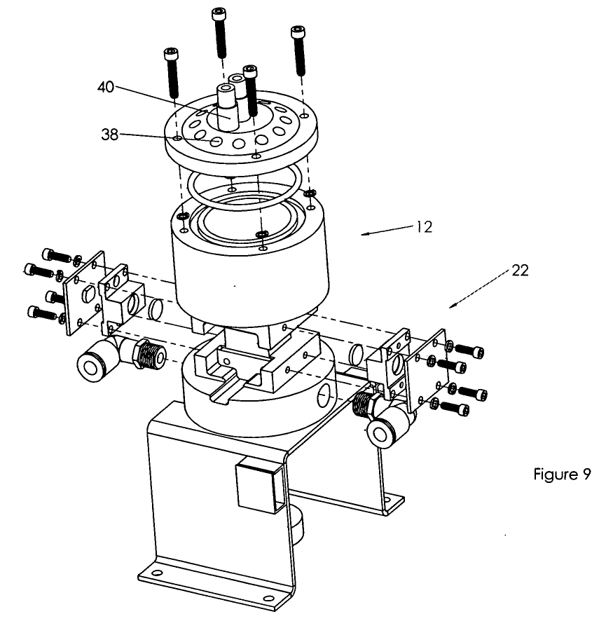

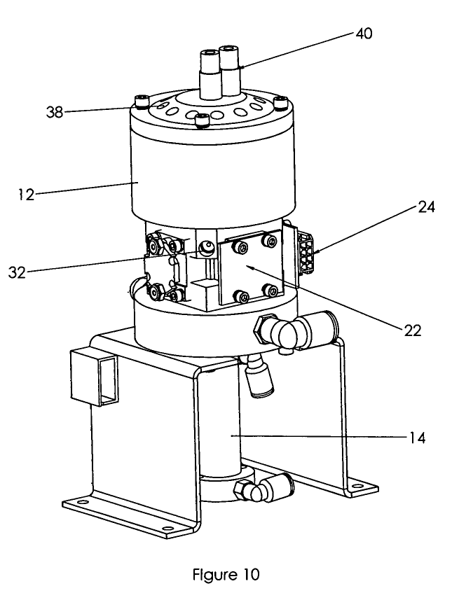

It will be understood that the connection of the components of the apparatus 10 may be made using equipment, such as bolts and screws, that is known in the art. The illustrations that include screws and bolts are merely provided as examples and are not meant to be limiting in any way. The exploded views in FIGS. 7-9 are provided as examples to illustrate the connection of the illustrated embodiment. It will be understood that the sensors of the present invention may be connected to the chamber by any means known in the art.

The chamber 12 of the illustrated embodiment of the present invention is preferably made from a clear cast acrylic. After the acrylic is machined, the surface is scratched and therefore no longer transparent, i.e. it is translucent. Only the surfaces that need to be transparent, as indicated above are polished clear. The top side of the titration chamber which includes injector ports 38 may be made from aluminium.

In addition to the testing described herein, the apparatus 10 may be connected to other vessels that are operable to perform additional testing on the sample, such as temperature measurement, viscosity etc.

It will be understood that the apparatus described herein may be used to analyse any sample and is not limited to the use for analysing drilling mud and drilling mud filtrate. The embodiment described herein is provided as an example only. Any sample requiring analysis may be fed into the chemical analysis apparatus described herein.

While this invention has been described with reference to illustrative embodiments and examples, the description is not intended to be construed in a limiting sense. Thus, various modification of the illustrative embodiments, as well as other embodiments of the invention, will be apparent to persons skilled in the art upon reference to this description. It is therefore contemplated that the appended claims will cover any such modifications or embodiments. Further, all of the claims are hereby incorporated by reference into the description of the preferred embodiments.

Any publications, patents and patent applications referred to herein are incorporated by reference in their entirety to the same extent as if each individual publication, patent or patent application was specifically and individually indicated to be incorporated by reference in its entirety.

1. An apparatus for chemically analysing a sample comprising:
a chamber operable for receiving at least one sample and at least one reagent, the chamber having a lower and an upper portion;
at least one optical sensor, connected to the chamber, operable to optically analyse the at least one sample; and
a piston located within the chamber, operable to move between the lower and the upper portions, the piston operable to seal the lower portion of the chamber when located in the lower portion and operable to allow the passage of the at least one sample and the at least one reagent through the chamber when located in the upper portion.

2. The apparatus according to claim 1, wherein the at least one optical sensor is selected from at least one transmissive sensor and at least one reflective sensor.

3. The apparatus according to claim 1, wherein the piston is operable to engage the inner surface of the lower portion of the chamber.

4. The apparatus according to claim 1, wherein the piston comprises a flexible portion located around the periphery of the piston, operable to frictionally engage the inner surface of the lower portion of the chamber.

5. The apparatus according to claim 1, further comprising an agitator connected to the chamber and operable to promote mixing of the at least one sample and the at least one reagent within the chamber.

6. The apparatus according to claim 1, wherein the transmissive sensor comprises at least one LED and at least one optical sensor.

7. The apparatus according to claim 6, wherein the at least one LED is located opposite the at least one optical sensor.

8. The apparatus according to claim 1, wherein the reflective sensor comprises at least one light source and at least one reflective optical sensor.

9. The apparatus according to, claim 8, wherein the at least one light source and the at least one reflective optical sensor are located on the same side of the chamber.

10. The apparatus according to claim 1, wherein the at least one sensor further comprises at least one focusing optic.

11. An apparatus for measuring ion concentrations in a sample comprising:
a chamber fluidly connected to a sample vessel and at least one reagent vessel and configured to receive a sample and at least one reagent from the vessels, the chamber being configured to allow for the transmission of light therethrough;
at least one optical sensor, connected to the chamber and configured to analyse the sample when received within the chamber; and
a piston located within the chamber, operable to move between a first position and a second position, the piston operable to provide a seal with the chamber when located in the first position, to contain the sample and the at least one reagent within the chamber, and operable to allow passage of the sample and the at least one reagent through the chamber when the piston is located in the second position.

12. The apparatus according to claim 11, wherein the at least one optical sensor is selected from at least one transmissive sensor and at least one reflective sensor.

13. The apparatus according to claim 11, wherein the piston is operable to engage the inner surface of the lower portion of the chamber.

14. The apparatus according to claim 11, wherein the piston comprises a flexible portion located around the periphery of the piston, operable to frictionally engage the inner surface of the lower portion of the chamber.

15. The apparatus according to claim 11, further comprising an agitator connected to the chamber and operable to promote mixing of the at least one sample and the at least one reagent within the chamber.

16. The apparatus according to claim 11, wherein the transmissive sensor comprises at least one LED and at least one optical sensor.

17. The apparatus according to claim 11, wherein the reflective sensor comprises at least one light source and at least one reflective optical sensor.

18. An apparatus for measuring ion concentrations in a sample comprising:
a chamber configured to receive a sample and at least one reagent, the chamber having a lower portion configured to allow the passage of light therethrough and an outlet port;
at least one optical sensor connected to the chamber adjacent the lower portion and operable to analyse the sample through the outer walls of the lower portion, when the sample is located therein;
a plug portion operable to move between a first position in which the plug portion covers the outlet port and a second position in which the sample and at least one reagent are fluidly connected to the outlet port, the plug portion configured to clean the lower portion of the chamber when moving between the first and second positions.

19. The apparatus according to claim 18, wherein the at least one optical sensor is selected from at least one transmissive sensor and at least one reflective sensor.

20. The apparatus according to claim 18, wherein the plug portion is operable to engage the inner surface of the lower portion of the chamber when moving between the first and second positions.
